(19) United States
(12) Patent Application Publication
(10) Pub. No.: US 2013/0307482 A1
(43) Pub. Date: Nov. 21, 2013

(54) Device and method for charging a plurality of parallel-connected non-aqueous electrolyte secondary batteries with parallel-connected chargers

(71) Applicant: Donald P.H. WU, Hsinchu County (TW)

(72) Inventor: Donald P.H. WU, Hsinchu County (TW)

(21) Appl. No.: 13/474,263

(22) Filed: May 17, 2012

(51) Int. Cl. H02J 7/00

(52) U.S. Cl. 320/126

(57) ABSTRACT

A device and method for charging a plurality of parallel-connected non-aqueous electrolyte secondary batteries with parallel-connected chargers, wherein a second charger which parallel connected to the first charger is additionally arranged to ensure that the charge process can be continued, and the charge process can be performed without battery management system.

### BACKGROUND OF THE INVENTION

1. Field of the Invention

The present invention relates to non-aqueous electrolyte secondary batteries, and more particularly to a device and method for charging a plurality of parallel-connected non-aqueous electrolyte secondary batteries with parallel-connected chargers.

2. Description of the Prior Art

Referring to FIG. 1, every serially-connected non-aqueous electrolyte secondary battery system (for instance, lithium-ion secondary battery, which is called secondary battery in the following descriptions) is provided with an expensive BMS (battery management system) 11a to maintain the potential difference between the secondary batteries 12a at a certain value and to prevent overcharge and overdischarge.

The BMS 11a generally serves to compensate the integrity of the secondary batteries 12a and maintain, charge balance. During the charge process, the BMS 11a, the secondary batteries 12a, and the charger 13a are connected in series, when any of the BMS 11a and the charger 13a or anyone of the secondary batteries 12a, is broken, all the secondary batteries 12a cannot be charged.

FIG. 2 shows that a charger 13b is used to charge a single secondary battery 12b which is equipped with a BMS 11b, and this arrangement also suffers the disadvantages of the above serially-connected non-aqueous electrolyte secondary battery system.

The present invention has arisen to mitigate and/or obviate the afore-described disadvantages.

### SUMMARY OF THE INVENTION

The primary object of the present invention is to provide a device and method for charging a plurality of parallel-connected non-aqueous electrolyte secondary batteries with parallel-connected chargers, wherein a second charger which parallel connected to the first charger is additionally arranged to ensure that the charge process can be continued, and the charge process can be performed without BMS.

To achieve the above object, a method for charging a plurality of parallel-connected non-aqueous electrolyte secondary batteries with parallel-connected chargers comprises using a first charger to charge the plurality of parallel connected non-aqueous electrolyte secondary batteries, the method is characterized, in that: a second charger which has the same charge current as the first charger and is parallel connected to the first charger to average a total output current.

A charge device for charging a plurality of parallel-connected non-aqueous electrolyte secondary batteries with parallel-connected chargers comprises a plurality of secondary batteries and a first charger. The plurality of secondary batteries each include a positive terminal and a negative terminal, the negative terminals of the secondary batteries are electrically connected to one another, and the positive terminals of the secondary batteries being electrically connected to one another. The first charger has a first positive output terminal electrically connected to the positive terminals, and a negative output terminal electrically connected to the negative terminals. The charge device is characterized in that: a second charger which has the same charge current as the first charger is additionally provided and includes a second output terminal electrically connected to the first positive output terminal, and a second negative output terminal electrically connected to the first negative output terminal.

### BRIEF DESCRIPTION OF THE DRAWINGS

FIG. 1 shows a conventional method for charging a plurality of serially-connected non-aqueous electrolyte secondary batteries with a single charger and a BMS;

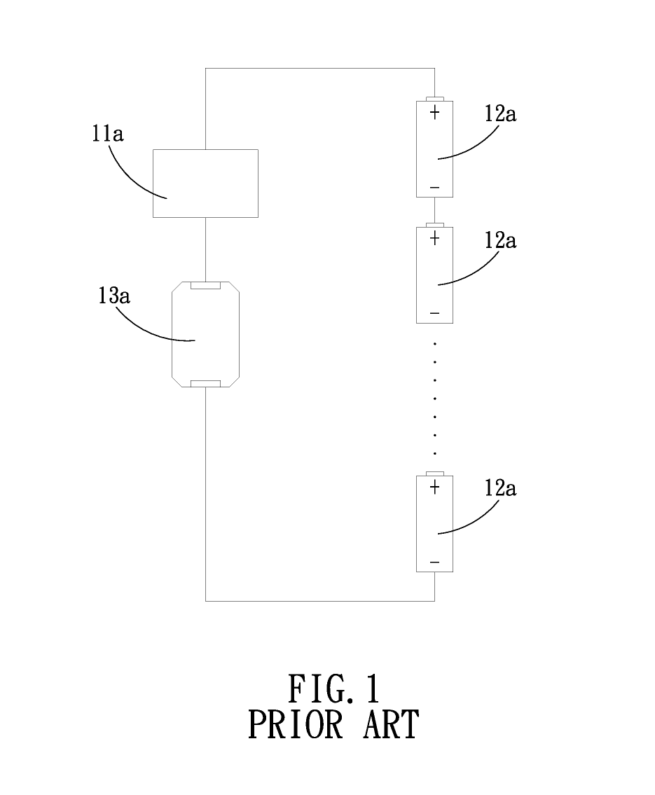

FIG. 2 shows a conventional method for charging a non-aqueous electrolyte secondary batteries with a single charger and a BMS;

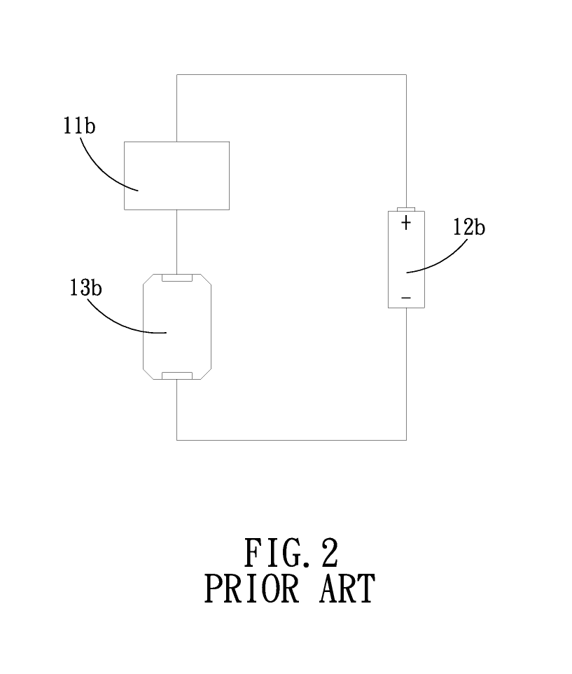

FIG. 3 shows a method in accordance with the present invention for charging two parallel-connected non-aqueous electrolyte secondary batteries with two parallel-connected chargers; and

FIG. 4 shows a method in accordance with the present invention for charging a plurality of parallel-connected non-aqueous electrolyte secondary batteries with a plurality of parallel-connected chargers.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

It is to be noted that the non-aqueous electrolyte secondary battery as mentioned in the following embodiment is lithium-ion secondary battery, which is abbreviated as secondary battery.

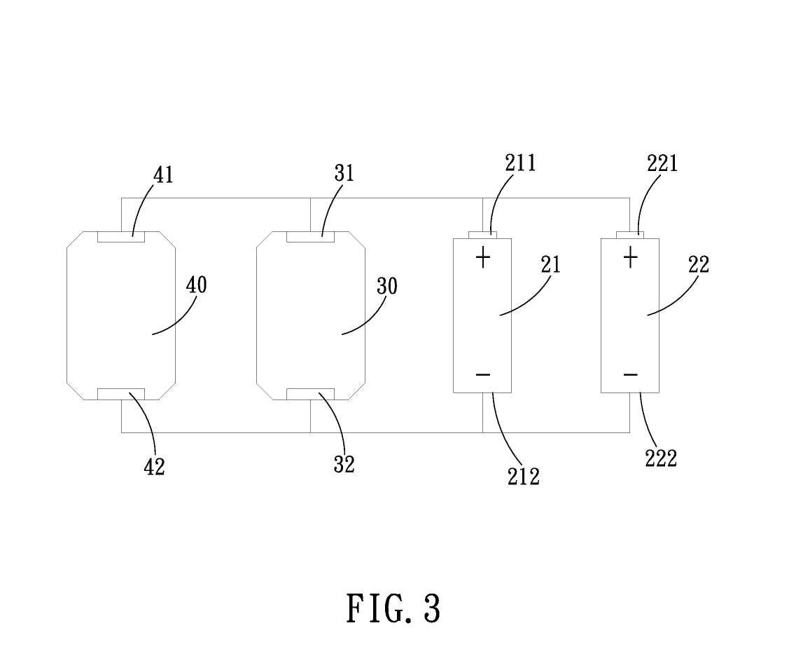

Referring to FIG. 3, a device for charging a plurality of parallel-connected non-aqueous electrolyte secondary batteries with parallel-connected chargers in accordance with the present invention comprises: two secondary batteries 21, 22, a first charger 30, and a second charger 40.

The two secondary batteries 21, 22 each include a positive terminal 211, 221 and a negative terminal 212, 222, and the negative terminals 212, 222 are electrically connected so as to make the secondary batteries 21, 22 parallel-connected to each other.

The first charger 30 includes a first positive output terminal 31 to be electrically connected to the positive terminals 211, 221, and, a negative output terminal 32 to be electrically connected to the negative terminals 212,. 222, so that the first charger 30 is parallel connected to the two-secondary batteries 21, 22.

The present invention is characterized in that: the present invention is additionally provided with a second charger 40 which has the same charge current as the first charger 30 and includes a second output terminal 41 for electrically connecting to the first positive output terminal 31, and a second negative output terminal 42 electrically connected to the first negative output terminal 32.

A method for charging a plurality of parallel-connected non-aqueous electrolyte secondary batteries with parallel-connected chargers in accordance with the present invention is such that the first charger 30 is used to charge the two parallel connected secondary batteries 21, 22. The second charger 40 is parallel connected to the first charger 30 to average the total output current. For example, in this embodiment, the total output current is one unit, the output current of the first and second chargers 30, 40 is 0.5 unit, respectively, and then the total one unit output current is transmitted to the secondary batteries 21, 22 to perform charge process.

When any of the first and second chargers 30, 40 or any of the secondary batteries 21, 22 is broken, or when one of the first and second chargers 30, 40 and one of the secondary batteries 21, 22 are broken, the other charger (the first or the second charger 30, 40) which is not broken and can work properly is still able to charge the other secondary battery (21 or 22) which is not broken and can work properly. Therefore, it ensures that charge process can be continued, and the charge process can be performed without BMS.

When one of the first and second chargers 30, 40 is broken, the other charger (30 or 40) which is not broken will simultaneously charge the two secondary batteries 21, 22, and in this state, the charge process lasts longer.

When one of the secondary batteries (21 or 22) is broken, the first and second chargers 30, 40 will simultaneously charge the other secondary battery (21 or 22) which is not broken, and the charge process takes less time.

When one of the first and second chargers 30, 40 and one of the secondary batteries 21, 22 are broken, the other charger (the first or the second charger 30, 40) which is not broken will charge the other secondary battery (21 or 22) which is not broken.

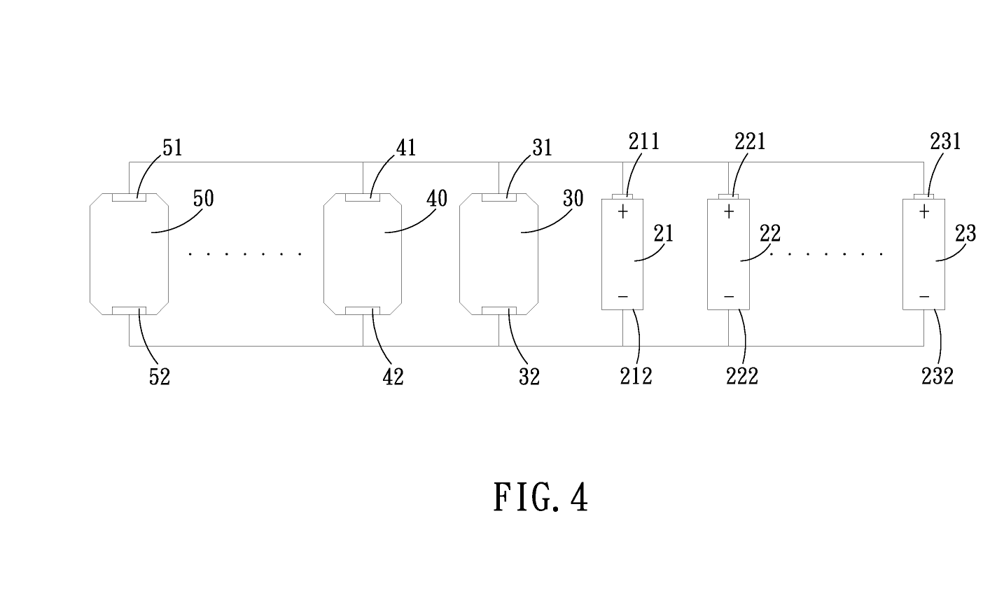

Referring to FIG. 4, another embodiment of the present invention is shown and additionally provided with a plurality of chargers 50 and secondary batteries 23 based on FIG. 3. The chargers 50 are parallel connected to the first and second chargers 30, 40, namely, the chargers 50 each include a positive output terminal 51 electrically connected to the first and second positive output terminals 31, 41, and a negative output terminal 52 electrically connected to the first and second negative output terminals 32, 42. The secondary batteries 23 are parallel connected to the secondary batteries 21, 22, and each have a positive terminal 231 electrically connected to the positive terminals 211, 221, and a negative terminal 232 electrically connected to the negative terminals 212, 222.

While we have shown and described various embodiments in accordance with the present invention, it is clear to those skilled in the art that further embodiments may be made without departing from the scope of the present invention.

What is claimed is:

1. A method for charging a plurality of parallel-connected non-aqueous electrolyte secondary batteries with parallel-connected chargers comprising using a first charger to charge the plurality of parallel connected non-aqueous electrolyte secondary batteries, the method being characterized in that: a second charger which has the same charge current as the first charger and is parallel connected to the first charger to average a total output current.

2. A device for charging a plurality of parallel-connected non-aqueous electrolyte secondary batteries with parallel-connected chargers comprising:
a plurality of secondary batteries each including a positive terminal and a negative terminal, the negative terminals of the secondary batteries being electrically connected to one another, and the positive terminals of the secondary batteries being electrically connected to one another;
a first charger with a first positive output terminal electrically connected to the positive terminals, and a negative output terminal electrically connected to the negative terminals;
the device being characterized in that: a second charger which has the same charge current as the first charger is additionally provided and includes a second output terminal electrically connected to the first positive output terminal, and a second negative output terminal electrically connected to the first negative output terminal.
